(19) United States
(12) Patent Application Publication
(10) Pub. No.: US 2020/0215395 A1
(43) Pub. Date: Jul. 9, 2020

(54) GOLF BALLS HAVING A HOLLOW CORE AND INTERNAL SKELETAL STRUCTURE

(71) Applicant: Acushnet Company, Fairhaven, MA (US)

(72) Inventors: Michael R. Madson, Easton, MA (US); Michael J. Sullivan, Old Lyme, CT (US); Mark L. Binette, Mattapoisett, MA (US)

(73) Assignee: Acushnet Company, Fairhaven, MA (US)

(21) Appl. No.: 16/820,889

(22) Filed: Mar. 17, 2020

Related U.S. Application Data
(63) Continuation-in-part of application No. 16/029,895, filed on Jul. 9, 2018.
Application No. 16/029,895 is a division of application No. 15/091,750, filed on Apr. 6, 2016, now Pat. No. 10,016,661.

(51) Int. Cl. A63B 45/00; A63B 37/00; B29C 64/129; B29C 64/124; B29C 64/135

(52) U.S. Cl. CPC A63B 45/00; B33Y 80/00; A63B 37/0058; A63B 37/0076; A63B 37/0075; A63B 37/0055; A63B 37/0007; A63B 37/0009; A63B 37/0073; A63B 37/0074; B29C 64/129; B29C 64/124; A63B 37/0047; A63B 37/005; A63B 37/0051; A63B 37/006; A63B 37/0091; A63B 37/0097; B29C 64/135; A63B 37/0066

(57) ABSTRACT

The present invention generally relates to golf balls having an internal skeletal structure that can be self-supporting. The golf ball preferably contains a spherical hollow inner core that is gas or liquid-filled. The ball further comprises an outer shell skeletal structure having a spherical shape and containing apertures that form hollow compartments. In one version, the skeletal structure supports itself and the space inside and around the skeletal structure is hollow. In another embodiment, the space is solid, for example, it may be foam-filled. In yet another version, the hollow space is filled with liquid. Multi-piece golf balls having outer cores, inner covers, and intermediate layers can be made.

### CROSS-REFERENCE TO RELATED APPLICATIONS

This application is a continuation-in-part of co-pending, co-assigned U.S. patent application Ser. No. 16/029,895 having a filing date of Jul. 9, 2018, now allowed, which is a divisional of co-assigned U.S. patent application Ser. No. 15/091,750 having a filing date of Apr. 6, 2016, now U.S. Pat. No. 10,016,661, the entire disclosures of which are hereby incorporated by reference.

### BACKGROUND OF THE INVENTION

### Field of the Invention

The present invention generally relates to multi-piece golf balls having an inner core and a cover. The balls have an internal skeletal structure that can be self-supporting. The core has an interior hollow region that is preferably gas or liquid-filled. Multi-piece golf balls having outer cores, inner covers, and intermediate layers can be made.

### Brief Review of the Related Art

Multi-piece, solid golf balls having a solid inner core protected by a cover are used today by recreational and professional golfers. The golf balls may have single-layered or multi-layered cores. Normally, the core layers are made of a highly resilient natural or synthetic rubber such as styrene butadiene, polybutadiene, polyisoprene, or ethylene acid copolymer ionomers. The covers may be single or multi-layered and made of a durable material such as ethylene acid copolymer ionomers or polyurethanes. Also, there may be intermediate (casing) layers disposed between the core and cover. Manufacturers of golf balls use different ball constructions to impart specific properties and features to the balls.

The core is the primary source of resiliency for the golf ball and is often referred to as the “engine” of the ball. The resiliency or coefficient of restitution (“COR”) of a golf ball (or golf ball component, particularly a core) means the ratio of a ball's rebound velocity to its initial incoming velocity when the ball is fired out of an air cannon into a rigid plate. The COR for a golf ball is written as a decimal value between zero and one. A golf ball may have different COR values at different initial velocities. The United States Golf Association (USGA) sets limits on the initial velocity of the ball so one objective of golf ball manufacturers is to maximize the COR under these conditions. Balls (or cores) with a high rebound velocity have a relatively high COR value. Such golf balls rebound faster, retain more total energy when struck with a club, and have longer flight distances as opposed to balls with lower COR values. Ball resiliency and COR properties are particularly important for long distance shots. For example, balls having high resiliency and COR values tend to travel a far distance when struck by a driver club from a tee. The spin rate of the ball also is an important property. Balls having a relatively high spin rate are particularly desirable for relatively short distance shots made with irons and wedge clubs. Professional and highly skilled amateur golfers can place a back-spin on such balls more easily. By placing the right amount of spin and touch on the ball, the golfer has better control over shot accuracy and placement. This control is particularly important for approach shots near the green and helps improve scoring.

Over the years, golf ball manufacturers have looked at developing different core constructions including hollow inner cores. For example, Sullivan et al., U.S. Pat. No. 6,120,393 discloses golf balls comprising a relatively soft, multi-piece core and a hard cover. The core comprises a hard, non-resilient, hollow inner core and a soft, resilient outer core layer. The hollow inner core may contain one or more gasses. The hard cover may be sized so that the ball has a larger diameter than traditional golf balls. Yoshida et al., U.S. Pat. No. 6,315,683 is generally directed to an over-sized (greater than 1.70 inches) hollow golf ball, where the hollow core is contained in a thermoset rubber layer and covered with a single ionomer cover. Sullivan et al., U.S. Pat. No. 7,946,932 discloses a golf ball having a core comprising a “fluid mass”, a first mantle layer surrounding the fluid mass and a second mantle layer surrounding the first mantle layer, and a cover. The center fluid mass can be a gas, liquid, gel, or paste. Nakamura, U.S. Pat. No. 8,262,508 generally describes a golf ball having a hollow center, a mid-layer, an inner cover, and an outer cover. The hollow center and mid-layer are both formed from a thermoset rubber composition. The hollow center has a diameter of 0.08 to 0.5 inches and the core layer has a low surface hardness of 25 to 55 Shore C. The golf ball is covered by a soft ionomer inner cover and hard ionomer outer cover. Golf balls having hollow centers are also described in Sullivan et al., U.S. Patent Application Publications 2014/0364252; 2016/0082320; 2016/0096078; and 2016/0101324.

Today, the golf industry has many high demands for the construction, physical properties, and playing performance of golf balls. The balls must have high resiliency (COR as described above), durability, wear-resistance, tear/shear-resistance, and the like. Many conventional hollow center golf balls have difficulty meeting these demands. Thus, it would be desirable to have a golf ball with a hollow center that can meet the many hard requirements of golf today. The present invention provides such golf balls having many advantageous features and benefits.

### SUMMARY OF THE INVENTION

The present invention provides golf balls having an internal skeletal structure that can be self-supporting. In one embodiment, the golf ball comprises: a) a core having at least one layer; b) a spherical-shaped shell having an outer surface, wherein the shell comprises a plurality of apertures on the outer surface that form hollow compartments; c) a cover layer having an outer surface, wherein the cover layer is disposed about the shell and comprises a plurality of dimples; and d) a hollow area disposed between the shell and cover, wherein the shape of the shell is capable of at least partially deforming upon impact by a golf club and recovering to its original shape after impact.

The core layer may have a hollow interior region that may be gas or liquid-filled. Preferably, the gas is selected from the group consisting of air, nitrogen, helium, argon, neon, carbon dioxide, nitrous oxide, and mixtures thereof. The hollow area disposed between the shell and cover also may be filled with these gasses. In another example, the hollow interior region of the core and hollow area disposed between the shell and cover comprises a liquid such as, for example, a water solution. The core and outer shell may be formed of a suitable material such as a thermoplastic or thermoset rubber. The outer shell can have a surface comprising segments in a lattice pattern. In another example, the outer shell can have a surface comprising segments in a grid pattern. The golf ball may further comprise a cover layer surrounding the outer shell. An intermediate layer may be disposed between the cover layer and outer shell.

In another embodiment, the golf ball comprises: a) a core having at least one layer; b) an outer shell disposed about the core, wherein the shell has a spherical shape and comprises apertures that form hollow compartments; and c) a foam-filled area disposed between the core and outer shell, wherein the shape of the outer shell is capable of at least partially deforming upon impact by a golf club and recovering to its original shape after impact. The foam-filled area may comprise a suitable foam such as, for example, polyurethane and ethylene vinyl acetate foams and mixtures thereof.

In yet another embodiment, the golf ball comprises: a) a spherical-shaped shell having an outer surface, wherein the shell comprises a plurality of apertures on the outer surface. These apertures form hollow compartments; b) a cover layer having an outer surface, wherein the cover layer is disposed about the shell and comprises a plurality of dimples; and c) a hollow area is disposed between the core and outer shell, wherein the shape of the outer shell is capable of at least partially deforming upon impact by a golf club and recovering to its original shape after impact. The shell and cover and hollow area may be a single, unitary piece. This integrated structure may be made in accordance with the methods of this invention.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a perspective view of a one-piece golf ball having a dimpled cover according to the present invention;

FIG. 2 is a cross-sectional view of a two-piece golf ball having a core and cover according to the present invention;

FIG. 3 is a cross-sectional view of a three-piece golf ball having a multi-layered core and single-layered cover according to the present invention;

FIG. 4 is a cross-sectional view of a four-piece golf ball having a multi-layered core and dual-layered cover according to the present invention;

FIG. 5A is a front view of a core having a non-continuous layer with a geodesic pattern according to the present invention;

FIG. 5B is a front view of a core having a non-continuous layer with a pattern of multiple triangles according to the present invention;

FIG. 5C is a front view of a core having a non-continuous layer with a pattern of multiple squares and equilateral triangles according to the present invention;

FIG. 5D is a front view of a core having a non-continuous layer with a pattern of multiple hexagons and squares according to the present invention;

FIG. 6A is a front view of a core having a non-continuous layer with a perforated shell having hexagonal-shaped cells according to the present invention;

FIG. 6B is a front view of a core having a non-continuous layer with a perforated shell having square-shaped cells according to the present invention;

FIG. 7 is a front view of a core having a non-continuous layer with a perforated shell having segments and nodes according to the present invention;

FIG. 8 is a perspective view of a core having a three-dimensional outer surface including projections and recesses according to the present invention;

FIG. 9 is a perspective view of a spherical core having multiple projections extending radially outwardly from the surface of the core according to the present invention;

FIG. 10 is a cross-sectional view of a spherical inner core showing a foamed geometric center, outer region, and outer surface skin according to the present invention;

FIG. 11 is a cross-sectional view of an inner core having a lattice-like interior according to the present invention;

FIG. 12 is a perspective view of one example of a golf ball according to the present invention showing an inner core and surrounding shell having a skeletal structure resembling a dimple pattern;

FIG. 13 is a cross-sectional view of one example of a golf ball according to the present invention showing an inner core and single surrounding layer containing coils that form air pockets in the layer;

FIG. 13A is a close-up view of the layer coils shown in FIG. 13 showing the coils;

FIG. 13B is a cross-sectional view of one example of a golf ball according to the present invention showing an inner core and multiple surrounding layers containing coils that form air pockets in the layers;

FIG. 14 is a perspective view of one example of a golf ball according to the present invention showing coils on the outer surface of the ball that radiate inwardly towards an inner core, wherein the coils on the outer surface resemble a dimple pattern;

FIG. 14A is a cross-sectional view of the golf ball shown in FIG. 14;

FIG. 15 is a perspective view of one example of a golf ball according to the present invention showing an outer surface with a polyhedral structure as opposed to a dimple pattern;

FIG. 15A is a close-up view of the golf ball's outer surface shown in FIG. 15;

FIG. 15B is a cut-away view of the golf ball shown in FIG. 15;

FIG. 16 is a cross-sectional view of one example of a golf ball according to the present invention showing an inner core and multiple surrounding layers containing spring-like structures;

FIG. 16A is a close-up view of the layers shown in FIG. 16 showing the spring-like structures;

FIG. 16B is a cut-away view of the golf ball shown in FIG. 16 showing the spring-like structures in the layers;

FIG. 16C is another embodiment of a spring-like structure that can be contained in the layers of a golf ball shown in FIG. 16; and

FIG. 16D is another embodiment of a spring-like structure that can be contained in the layers of a golf ball shown in FIG. 16.

### DETAILED DESCRIPTION OF THE INVENTION

Golf balls having various constructions may be made in accordance with this invention. For example, golf balls having one-piece, two-piece, three-piece, four-piece, and five or more-piece constructions wherein the term “piece” refers to any core, intermediate (casing) layer, or cover, or other component of a golf ball construction. The golf balls of the present invention have an internal skeletal structure as described further below.

Skeletal Structure

In one embodiment of the golf balls of this invention, the ball has an internal skeletal structure. The skeletal structure is capable of compressing and recovering (to its original shape) from golf club impact and is resilient enough to replace a conventional golf ball core or intermediate layer. In this embodiment, at least one layer of the golf ball comprises the skeletal structure. Preferably, the inner core or surrounding intermediate layer comprises the skeletal structure.

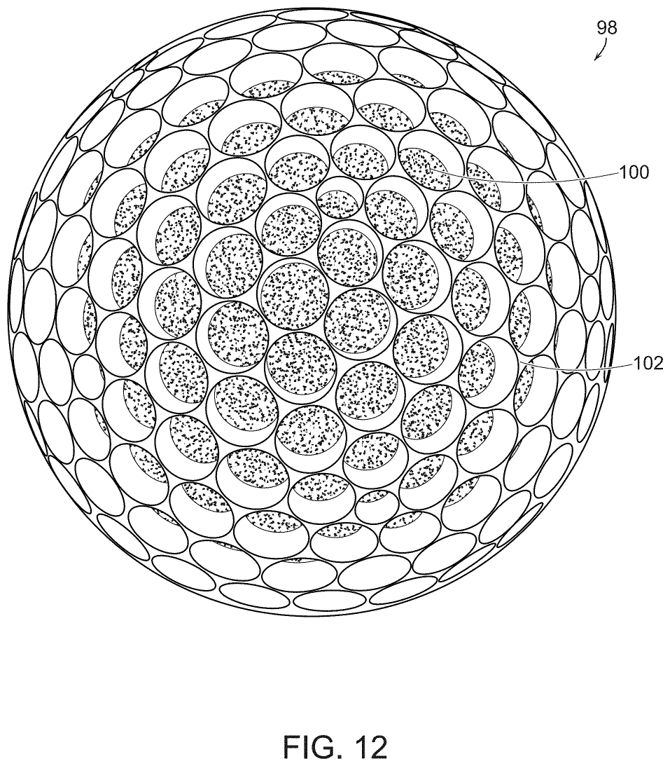

Referring to FIG. 12, one example of a golf ball (98) having an internal skeletal structure is shown. The ball contains a spherical hollow inner core (100) that is preferably gas or liquid-filled as described further below. The ball further comprises an outer shell skeletal structure (102) having a spherical shape and containing apertures that form hollow compartments. In one version, the skeletal structure supports itself and the space inside and around the skeletal structure is hollow. In another embodiment, the space is solid, for example, it may be foam-filled. This may help make the manufacturing of the outer layers applied over the skeleton easier. Another option is to fill the hollow space with liquid after the core is assembled. In this embodiment, the skeletal structure has a generally outer surface with a plurality of apertures that resemble a dimple pattern found on the outer surface of a conventional golf ball. Traditional dimples are generally circular or other shaped depressions that are formed on the outer surface of the golf ball. These dimples are generally formed where a dimple wall slopes away from the outer surface of the ball forming the depressions. However, it is recognized that the skeletal structure can have other geometric patterns and shapes. For example, the skeletal structure can have a lattice or grid pattern and there can be projections and protrusions extending from the skeleton such as ridges, bumps, nubs, hooks, juts, ribs, structural segments, brambles, ribs, spines, points, and the like.

Also, in the embodiment of the ball having the internal skeletal structure as shown In FIG. 12, the core (100) has a spherical shape. It should be understood that the term “spherical” as used herein includes surfaces and shapes which may have minor, insubstantial deviations from the perfect ideal geometric spherical shape. Further the surfaces of the shell as well as the core may likewise incorporate intentionally designed patterns and still be considered “spherical” within the scope of this invention.

In another embodiment, an annular ring band-belt of a flexible or relatively rigid or semi-rigid resilient material is used as the skeletal supporting structure. A wide variety of flexible and rigid or semi-rigid materials can be used in accordance with this invention. Such flexible, rigid, and semi-rigid materials are described in further detail below.

These golf ball construction embodiments and others described herein are similar to pneumatic tires that can be used under reduced internal pressure, that is, tires that run under a “run-flat” condition. Different “run-flat” tires are generally known. For example, one such tire is a tire of the internal wheel type, in which an internal ring wheel made of a metal or a synthetic resin is attached to a rim at a portion inside the air chamber of the tire. Another tire is a tire of the side reinforcement type, in which a layer of a relatively rigid rubber composition is disposed in the vicinity of a carcass in an area ranging from the bead portion to the shoulder portion of the tire side wall. These “run-flat” tires are described, for example, in Nishikawa et al., U.S. Patent Application Publication 2002/0009608.

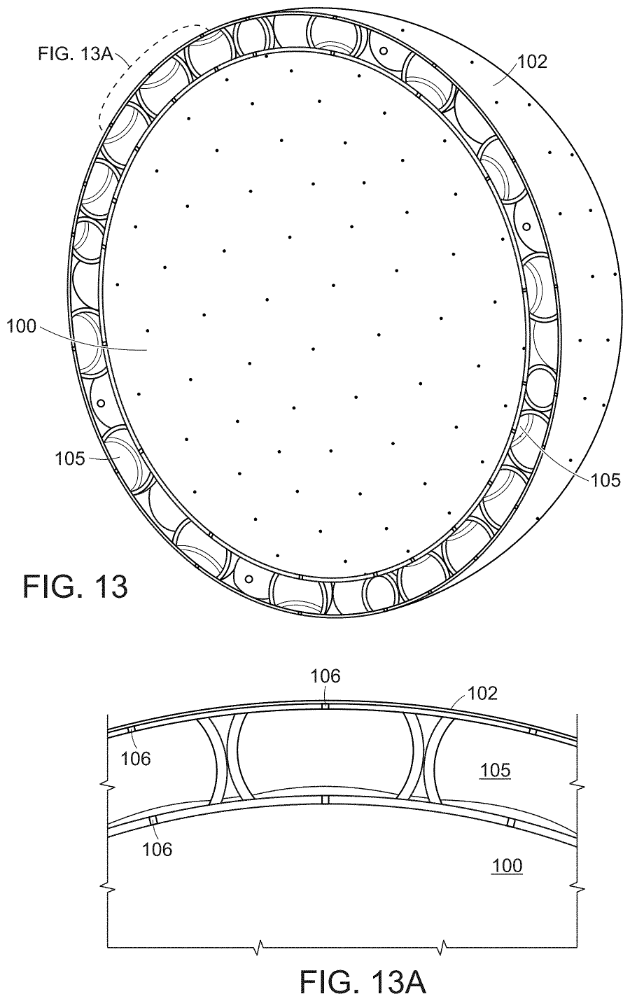

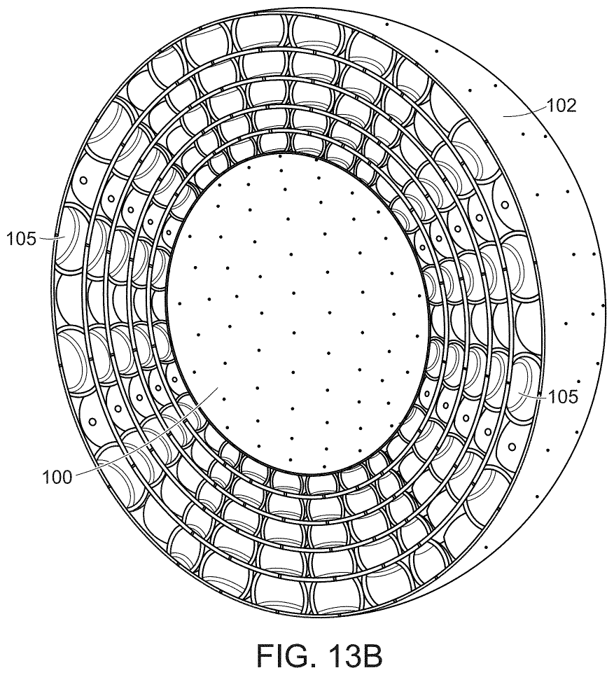

In another embodiment, the intermediate layer (102) may contain multiple hollow tubes or coils (105) that radiate inwardly. The intermediate layer containing the coils (105) can surround a hollow center (100). These elongated hollow tubes or coils may be formed of a thin flexible membrane-type material. The thin walls surround a hollow center portion to form the elongated tube or coil. The coils may contain tiny vent holes. The center portion acts as an air pocket and compresses. As shown in FIGS. 13, 13A, and 13B, multiple coils (105) forming multiple flexible air pockets (106) can be arranged in the layer. The wall thickness, material, and cross-sectional geometry of the coils (105) will help determine the compression and COR of the layers.

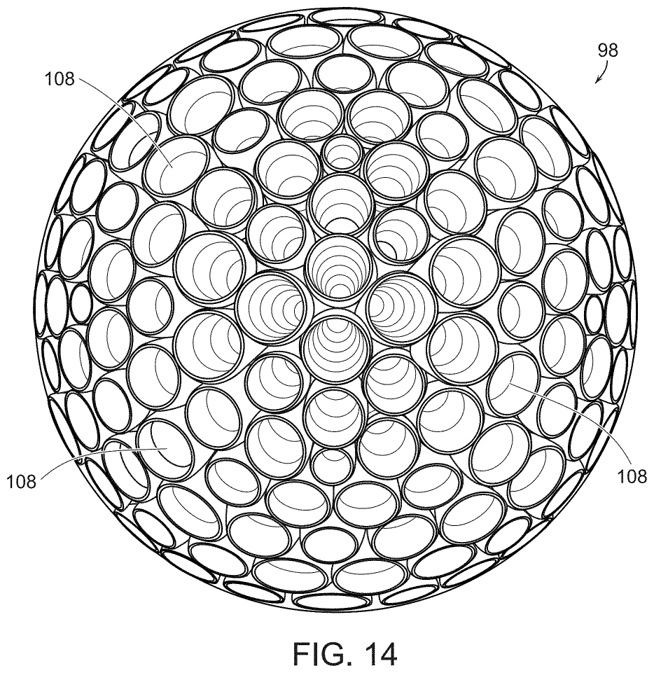

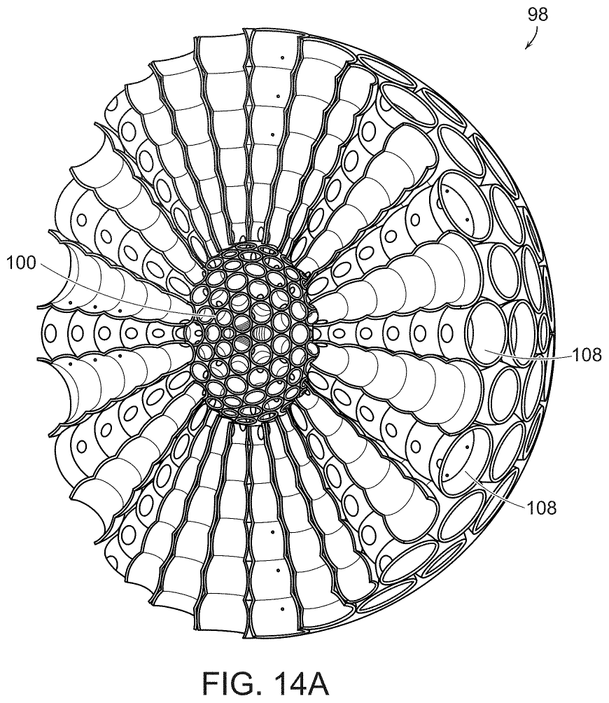

Referring to FIGS. 14 and 14A, in another embodiment, the golf ball (98) contains coils (108) that are not encapsulated in a layer; rather, the coils just radiate inwardly.

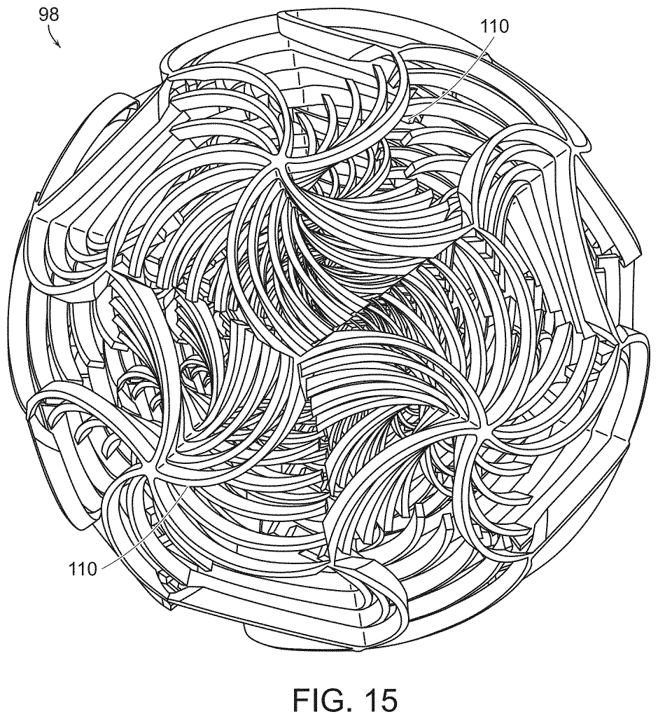

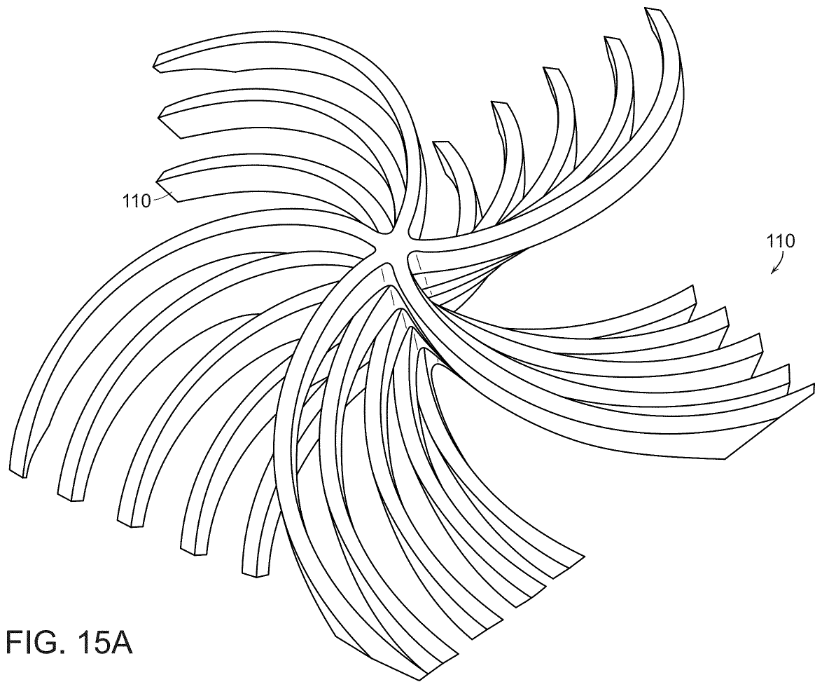

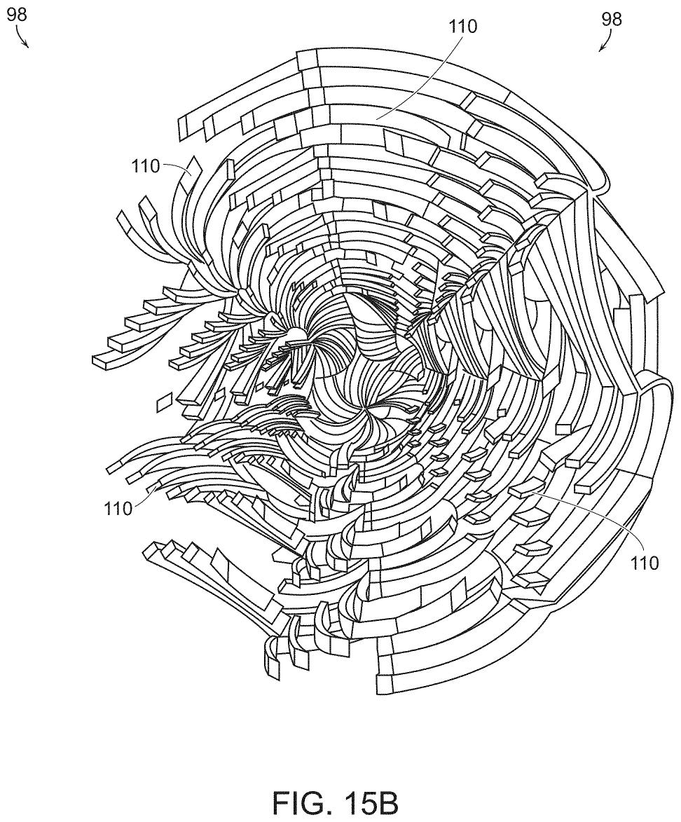

Turning to FIG. 15, in another embodiment, the composition is patterned around the golf ball (98) via a polyhedral pattern with segments (110) as opposed to a dimple pattern found in FIGS. 13, 13A, and 13B.

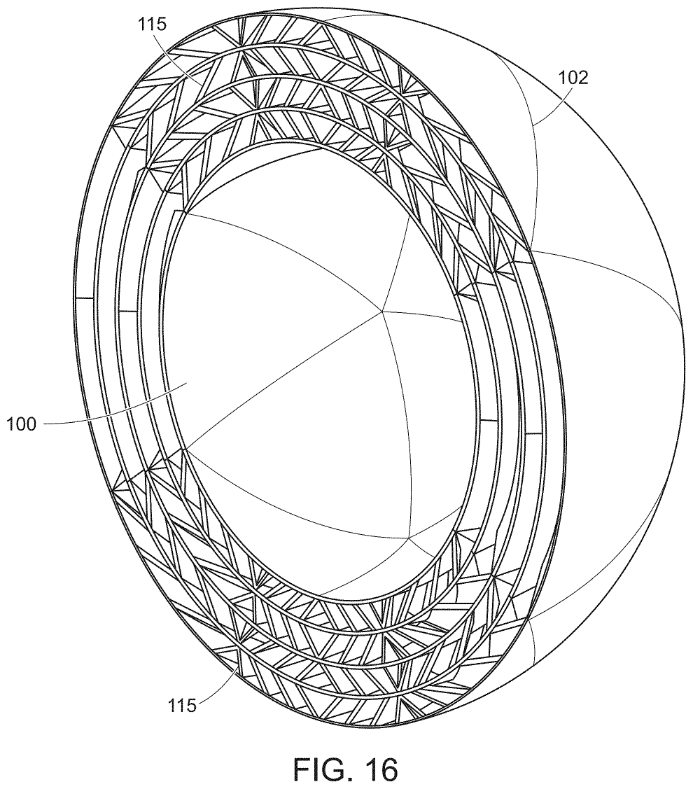

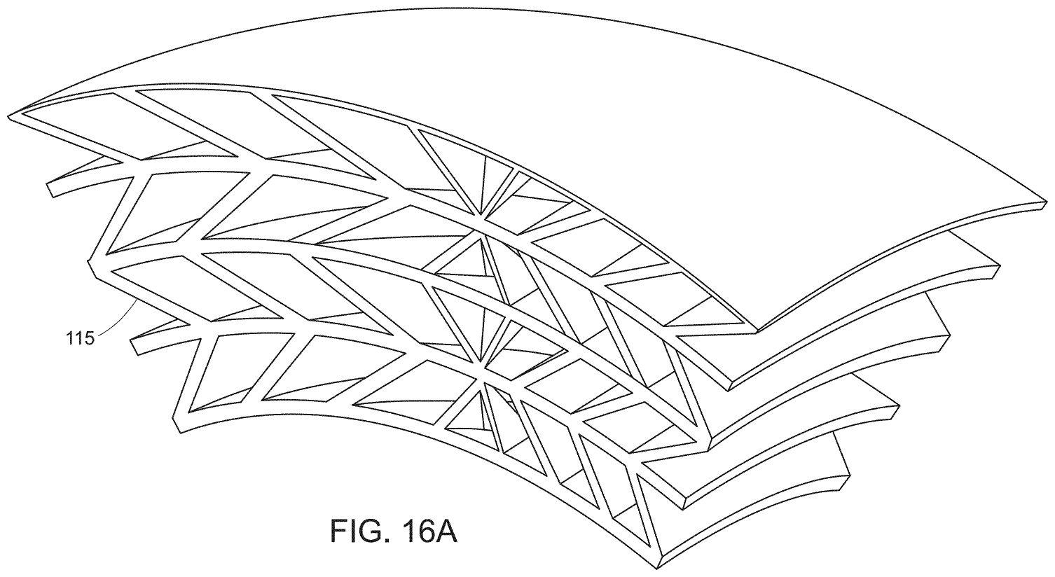

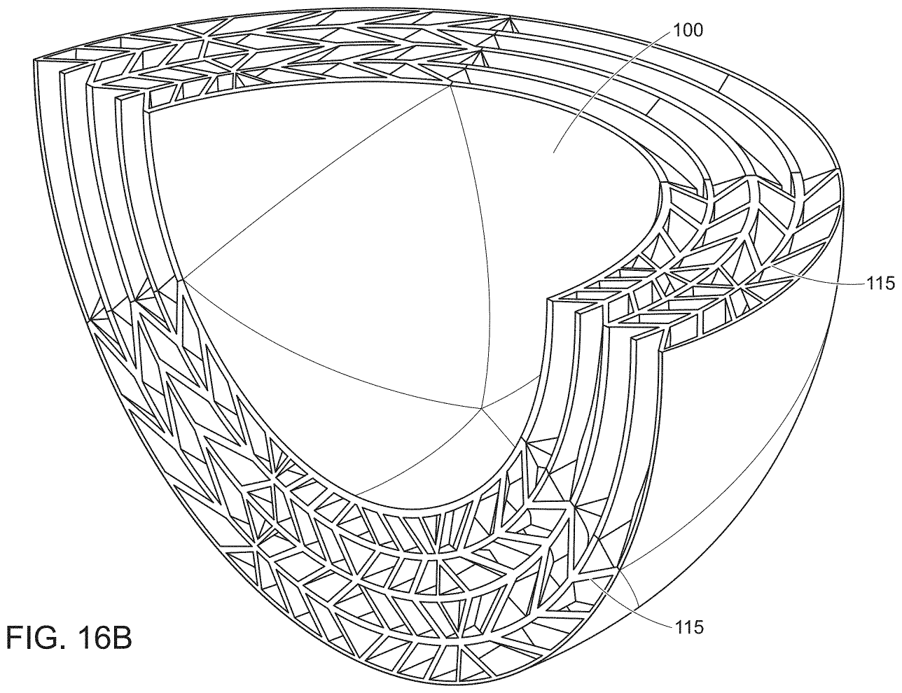

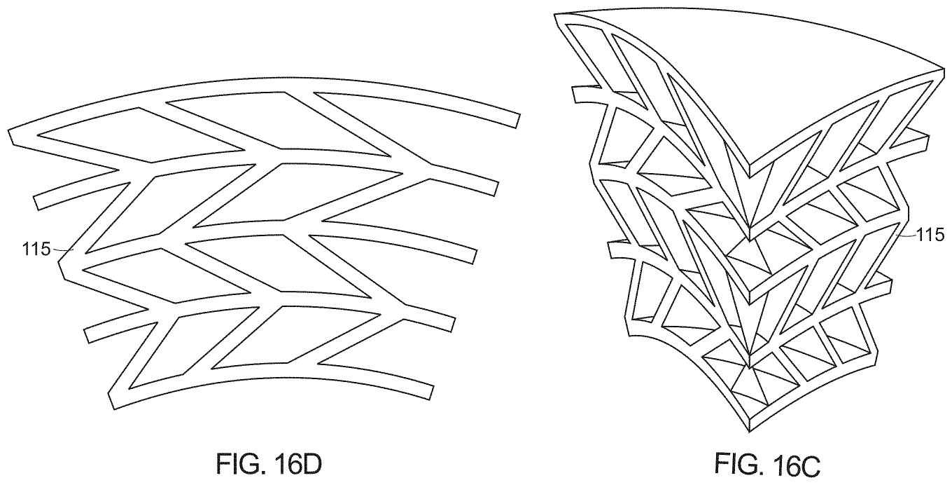

Turning to FIGS. 16-16D, in another embodiment, the center (100) of the golf ball is surrounded by layers (102) containing spring-like structures (115). The skeletal structure is capable of compressing and recovering (to its original shape) from golf club impact because of the spring-like structures (115). The ball acts in a similar manner to “run-flat tires” as described above.

In another embodiment, the skeletal structure may include a series of fins or spines emanating from a central point (hub) in a relatively symmetric array. The fins may be curved /slanted with respect to path extending outwardly from the geometric center. Support rods that are roughly perpendicular to the fins may be added to further strengthen the skeletal structure.

In another embodiment, the skeletal structure is a cage-like structure that may have a spherical exterior or polygonal shape, wherein there are optionally one or more connecting rods, bars/columns made of a flexible material that are attached to two sides of the structure, for example, in a pole-to-pole fashion.

As discussed above, an annular ring band-belt of a flexible or relatively rigid or semi-rigid resilient material can be used as the skeletal supporting structure. Suitable thermoset rubber materials that may be used to form the skeletal supporting structure include, but are not limited to, polybutadiene, polyisoprene, ethylene propylene rubber (“EPR”), ethylene-propylene-diene (“EPDM”) rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and blends of two or more thereof. The thermoset rubber composition may be cured using conventional curing processes. Suitable curing processes include, for example, peroxide-curing, sulfur-curing, high-energy radiation, and combinations thereof.

Elastomeric thermoplastics also can be used. These include, for example, polyurethanes; polyureas; copolymers, blends and hybrids of polyurethane and polyurea; olefin-based copolymer ionomer resins (for example, Surlyn® ionomer resins and DuPont HPF® 1000 and HPF® 2000, commercially available from DuPont; Iotek® ionomers, commercially available from ExxonMobil Chemical Company; Amplify® IO ionomers of ethylene acrylic acid copolymers, commercially available from The Dow Chemical Company; and Clarix® ionomer resins, commercially available from A. Schulman Inc.); polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax® thermoplastic polyether block amides, commercially available from Arkema Inc; cross-linked trans-polyisoprene and blends thereof; polyester-based thermoplastic elastomers, such as Hytrel®, commercially available from DuPont or RiteFlex®, commercially available from Ticona Engineering Polymers; polyurethane-based thermoplastic elastomers, such as Elastollan®, commercially available from BASF; synthetic or natural vulcanized rubber; and combinations thereof. Castable polyurethanes, polyureas, and hybrids of polyurethanes-polyureas are particularly desirable because these materials can be used to make a golf ball having high resiliency and a soft feel. By the term, “hybrids of polyurethane and polyurea,” it is meant to include copolymers and blends thereof.

Other suitable thermoplastic polymers that may be used to form the inner and outer cover layers include, but are not limited to, the following polymers (including homopolymers, copolymers, and derivatives thereof): a) polyesters, b) polyamides, c)polyurethanes, polyureas, polyurethane-polyurea hybrids, d) fluoropolymers, e) polystyrenes, f) polyvinyl chlorides, g) polycarbonates, h) polyethers, i) polyimides, polyetherketones, polyamideimides; and j) blends of two or more of the foregoing.

Lightweight metal materials having high mechanical strength such as, for example, aluminum, magnesium, aircraft aluminum, beryllium, carbon fiber, titanium, carbon fiber composites, metal alloys, and the like also can be used for forming the skeletal supporting structure in accordance with this invention.

Flex Modulus

In one embodiment, the skeletal structure and particularly the outer shell of this invention is relatively stiff and it has a high flex modulus. The flex modulus refers to the ratio of stress to strain within the elastic limit (when measured in the flexural mode) and is similar to tensile modulus. This property is used to indicate the bending stiffness of a material. The flexural modulus, which is a modulus of elasticity, is determined by calculating the slope of the linear portion of the stress-strain curve during the bending test. If the slope of the stress-strain curve is relatively steep, the material has a relatively high flexural modulus meaning the material resists deformation. The material is more rigid. If the slope is relatively flat, the material has a relatively low flexural modulus meaning the material is more easily deformed. The material is more flexible. The flex modulus can be determined in accordance with ASTM D790 standard among other testing procedures. In another embodiment, the skeletal structure and particularly the outer shell of this invention is relatively flexible and it has a low flex modulus. More particularly, in one embodiment, the outer shell has a flex modulus lower limit of 5,000, 10,000, 20,000 or 30,000 or 40,000 or 50,000 or 60,000 or 70,000 or 80,000 or 90,000 or 100,000 or greater. In general, the properties of flex modulus and hardness are related, whereby flex modulus measures the material's resistance to bending and hardness measures the material's resistance to indentation. In general, as the flex modulus of the material increases, the hardness of the material also increases.

Core Structure

In conventional golf ball manufacturing operations, the core has a spherical structure and is made using a compression molding process. The rubber composition contains a mixture of ingredients including free-radical initiator such as peroxides, cross-linking co-agents such as zinc diacrylate (ZDA), and additives. The ingredients are mixed on a mill to form slugs and then compression-molded to form solid spheres that will be used as the core. Heat and pressure are applied during the molding process. For example, a molding cycle at a temperature of 140 to 200° C. for a time 3 to 20 minutes can be used. Injection-molding processes also may be used. In contrast to such traditional molding methods, the present invention uses a three-dimensional additive manufacturing process to manufacture the core or other piece (component) of the golf ball.

In the present invention, the hollow interior region of the core preferably contains a fluid. A wide variety of materials or fluids, including solutions, liquids, and gases can be used to fill the hollow core. For example, the hollow core may contain gas, at a pressure below atmospheric, atmospheric, or above atmospheric pressure. Preferably, the core contains gas at a pressure greater than atmospheric pressure. Suitable gasses include, for example, air, nitrogen, helium, argon, neon, carbon dioxide, nitrous oxide and mixtures thereof. The gas is preferably nitrogen or some other relatively stable and inert gas. The gas can be introduced into the hollow core by conventional techniques known in the art.

In other embodiments, the hollow core can contain liquids such as, for example, water; polyols, such as glycerine, ethylene glycol and the like; paste; foams; oils; water solutions, such as salt in water, corn syrup, salt in water and corn syrup, or glycol and water; and mixtures thereof. Other fluids include pastes, colloidal suspensions, such as clay, barytes, carbon black in water or other liquid, or salt in water/glycol mixtures; gels, such as gelatin gels, hydrogels, water/methyl cellulose gels and gels comprised of copolymer rubber-based materials such a styrene-butadiene-styrene rubber and paraffinic and/or naphthenic oil; or melts including waxes and hot melts. Hot-melts are materials which at or about normal room temperatures are solid but at elevated temperatures become liquid. The fluid center can also be a reactive liquid system which combine to form a solid. Examples of suitable reactive liquids are silicate gels, agar gels, peroxide cured polyester resins, two-part epoxy resin systems and peroxide cured liquid polybutadiene rubber compositions. It is understood by one skilled in the art that other reactive liquid systems can likewise be utilized depending on the physical properties of the liquid center shell and the physical properties desired in the resulting finished golf balls. U.S. Pat. No. 6,200,230, 5,683,312, and 5,150,906 contain disclosures of preferred liquids for use in the shell and their entire disclosures are incorporated by reference herein. The hollow core has a polymeric shell can be formed from a wide variety of materials having high mechanical strength and resiliency. Thermoplastic and thermoset materials as described above can be used to form such shells.

Three-Dimensional Printing

A preferred method for making the above-described skeletal structure is by three-dimensional additive manufacturing systems. In general, additive manufacturing refers to systems that use three-dimensional (3D) digital data from an object to build-up the object by depositing metal, plastic, or other material layer-by-layer as opposed to subtractive systems used to build-up the object by removing material (for example, machining/milling an object from a solid block of polymer material or metal). In these systems, computer software is used to collect digital data on the shape and appearance of a real object. A digital model is created and a series of digital cross-sectional slices of the model are taken.

These additive manufacturing systems can be used to produce intricate skeletal structures and designs. 3-D printing methods can be used to form skeletal structures having various geometric shapes and patterns These shapes can be in arranged randomly or in a geometric order, for example, in a grid or lattice or a series of raised rows and raised columns. These 3-D printing methods also allow for a skin or surface layer to be made “over” the skeletal structure at the same time, thus eliminating the need for a second step of applying a skin (over-molding) to a pre-molded skeleton. These steps also make it easier to form a hollow-sectioned core or layer. Also, there can be extending members projecting from the surfaces of the skeletal structures. These projections and protrusions can have any suitable shape and dimensions, and be arranged in any desired pattern. For example, these projections and protrusions can be in the form of ridges, bumps, nubs, hooks, juts, ribs, segments, brambles, ribs, spines, points, and the like.

The 3-D printing methods also can be used to form gyroid skeletal structures made from graphene or borophene. Graphene has a hexagonal network made of carbon atoms on each of the six vertices—the carbon atoms can bind to as many as six other atoms to create a flat, hexagonal structure; while borophene also has a hexagonal network, except it is made of boron atoms. Graphene and borophene are extremely flexible, strong, and lightweight. The gyroids are infinitely connected triply periodic minimal surfaces.

Generally, in a three-dimensional (3D) printing system, each slice is reconstructed by depositing a layer of the material and then solidifying it. The digital information is sent to the three-dimensional printer that successively adds thin layers of material (for example, a powder), until the object is produced. The layers are joined together in various ways, and different materials, for example, metal, plastic, ceramic, or glass). For example, in a three-dimensional (3D) printing process, an inkjet printer head can spray a thin layer of liquid plastic onto a build tray. The liquid layer is cured and it solidifies by irradiating it with ultraviolet (UV) light. The build tray is lowered by a layer, and the process is repeated until the model is completely built. In another 3D printing process, powder is used as the printing medium. The powder is spread as a thin layer on the build tray, and then it is solidified with a liquid binder. In Fusion Deposit Modeling (FDM), the nozzles trace the cross-section pattern for each particular layer. An extrusion head deposits a thin layer of the molten thermoplastic material onto a platform. The molten material hardens prior to application of the next layer. In Multi-Jet Modeling (MJM), a printing head that can move in multiple directions (x, y, and z coordinates) includes multiple small jets that apply the thermoplastic material to a platform layer-by-layer, and the material solidifies. In selective laser sintering (SLS), small powder particles are deposited in the desired pattern and then a laser is used to fuse the powder particles together. Other systems include laminate object manufacturing (LOM) and rapid prototyping. In stereolithography (SLA), liquid resin is applied to an elevator platform. The object is built layer-by-layer. For each layer, a laser beam traces a cross-section pattern of the object on the surface of the liquid resin. After the pattern has been traced, the elevator platform descends by the appropriate distance and the process is repeated. The platform is re-coated with liquid resin, and another pattern is traced. In this way, the layers are joined together and the object is built layer-by-layer. After the object is built, it is cleaned of any excess resin by immersing it in a chemical bath and the object is subsequently cured in an ultraviolet oven.

In one method of this invention, a three-dimensional piece is made according to an ink-jet printing method including the following steps. Digital Information is provided for making the piece and this information is sent to a three-dimensional ink-jet printer. The ink jet printer sprays a polymeric material onto a support platform according to the digital information. The support platform is lowered by a precise level of thickness for the layer, and the process is repeated until the three-dimensional piece is formed. The polymeric material may be applied to a support or building layer if needed. After the final three-dimensional piece is formed, the support layers are optionally washed out with either water or solvent. Since different polymeric materials can be loaded into the ink-jet printer and different spray nozzles can be used to apply the material, the final three-dimensional object can be formed from more than one material. The final three-dimensional object can comprise different materials.

In another system, a three-dimensional (3D) piece can be made according to a continuous liquid interface printing method that includes the following steps. First, cross-sectional digital information for making the piece is sent to a light-processing digital imaging unit. The method uses a bath member (for example, basin) having a bottom surface with an oxygen-permeable, ultraviolet (UV) light-transparent window is used. The bath contains a UV-light polymerizable liquid resin. The digital imaging unit is used to project a continuous sequence of UV light images through the window of the bath according to the digital information. In this way, the digital information for making the three-dimensional object is illuminated and transmitted to the liquid resin. The illuminating UV light causes the liquid resin to solidify and form the three-dimensional piece on a support plate located above the bath. The construction of the piece is defined by the cross-sectional digital images. The three-dimensional piece grows on the support plate by continuously elevating the plate and drawing the object out of the resin bath while the imaging unit sends new UV images to the resin bath.

In general, any suitable light-curable polymerizable material may be used in accordance with this invention. These include, but are not limited to, sol-gels, polyesters, vinyl ethers, acrylates, methacrylates, polyurethanes, polyureas, bio-absorbable resins, silicones, epoxides, cyanate esters, hydrogels, investment casting resins, polycarbonates, and thiolenes. Typically, a mixture of light-curable oligomers and monomers are used in the light-curable polymerizable material. Mixtures of different polymerizable materials having different polymerization rates, viscosities, and other properties can be added to the resin bath and the mixtures can be used to make the three-dimensional pieces. The olgiomers typically include epoxides, urethanes, polyethers, and polyesters. These oligomers are typically functionalized by an acrylate. The monomers used help control the cure speed, cross-link density, and viscosity of the resin along with other properties. These monomers include, for example, styrene, N-vinylpyrrolidone, and acrylates. Anionic or cationic photoinitiators can be used to initiate polymerization when irradiated with light. These photoinitiators include styrenic compounds, vinyl ethers, N-vinyl carbazoles, lactones, lactams, cyclic ethers, cyclic acetals, and cyclic siloxanes.

In contrast to 3D ink-jet printing, where there are many separate and discrete steps needed to build-up the part layer-by-layer, this liquid interface printing process goes non-stop and does not build by layers. In this liquid interface process, the print speed is basically controlled by the polymerization rate and viscosity of the liquid resin. This continuous liquid interface printing process for making three-dimensional objects is generally described in the patent literature including, DeSimone et al., U.S. Pat. Nos. 9,216,546; 9,211,678; 9,205,601; and Published US Patent Applications 2015/0072293 and 2014/0361463, the disclosures of which are hereby incorporated by reference. Continuous liquid interface printing systems are available from Carbon 3D, Inc. (Redwood City, Calif.).

The methods of the present invention can be used to make the inner core as well as any other component for the golf ball including outer core and intermediate (casing) layers and covers. Although the three-dimensional pieces are described primarily herein as being inner cores, it is recognized that other three-dimensional pieces for the golf ball can be made. A three-dimensional piece made in accordance with this invention can have a have a spherical uniform structure. Alternatively, the three-dimensional piece can have a non-spherical, non-uniform structure and can be used as any component in the ball. Examples of such structures are described further below.

These structures include, for example, lattice or sponge like interiors including structures that have a high strength to weight ratio design; shell components of the golf ball; multi-layer constructions printed at the same time using two materials that are UV curable materials that react at different wavelengths; shells with micro-surfaces to promote adhesion; shells with micro-surfaces used as tie layers; shells with subsurface features used to precisely locate added mass, or highly damped materials; shells, lattices or geodesics with varying scale features to control weight distribution or flexural stiffness; unique solid or shell geometries created from 3D moebius or manifolds or fractrals or organic based structures; lattice or geodesic structures including undercuts; mating shells with Velcro™-like structures for holding layers together; lattice structures to be cast with urethane to create a double cover; lattice structures to be injection-molded to create a double cover; fabrication of monolithic printed parts that have no striations caused by 2D layering of material, and are manufactured to a precise tolerance (for example, <25 microns or <16 microns or <8 microns). The structures may have a wide variety of geometric shapes including, but not limited to, spherical, circular, oval, triangular, square, pentagonal, hexagonal, heptagonal, octagonal, and the like.

As discussed above, golf balls having various constructions can be made in accordance with this invention. For example, golf balls having one-piece, two-piece, three-piece, four-piece, and five-piece constructions with single cores or multi-layered core sub-assemblies and intermediate (casing) layers and covers can be made.

Core Structure—Geometric Projections and Thickness

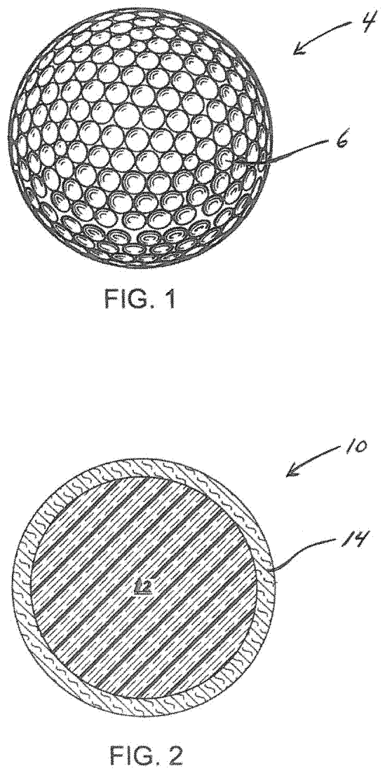

Referring to FIGS. 1-4, in some embodiments, the inner core has a substantially spherical shape and uniform thickness. In these embodiments, the inner core includes a geometric center and outer surface that are substantially free of any projections or extending members. That is, the inner core has a substantially uniform thickness and substantially smooth surface in these examples. Also, the core can have a foam or sponge-like composition. If needed, the outer surface of the core can have a uniform surface roughness to promote adhesion to other layers in the golf ball construction.

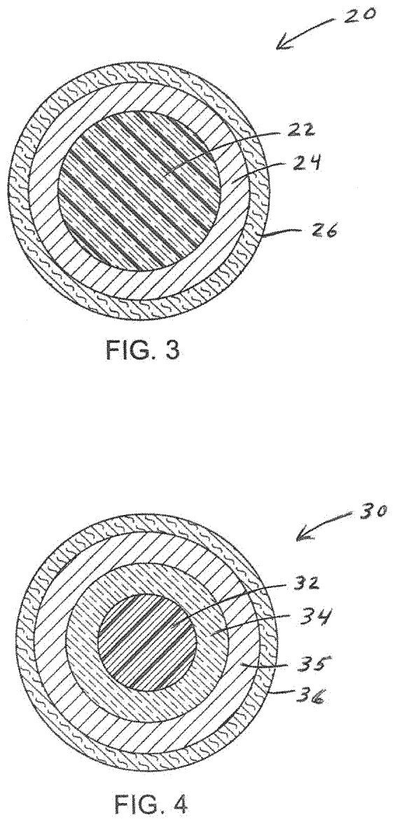

One version of a golf ball that can be made in accordance with this invention is generally indicated at (4). In FIG. 1, the ball (4) is one-piece with a unitary structure. The outside surface of the ball contains dimples (6) for improved aerodynamic performance. In FIG. 2, the two-piece ball (10) contains an inner core (12) and a cover (14). Turning to FIG. 3, the ball (20) contains a dual-core having an inner core (center) (22) and outer core layer (24) surrounded by a single-layered cover (26). Referring to FIG. 4, in another version, the golf ball (30) contains a dual-core having an inner core (center) (32) and outer core layer (34). The dual-core (14) is surrounded by a multi-layered cover having an inner cover layer (35) and outer cover layer (36). The dual-core constructions (inner core and surrounding outer core layer) may be referred to as a ball sub-assembly.

In other embodiments, the inner core structure is non-spherical and has a non-uniform thickness and/or contains projecting members. These extending members on the outer surface of the core may be arranged in any suitable geometric pattern. For example, the extending members may be arranged in a grid or lattice; or a series of rows and raised columns. These extending members may be in the form of ridges, bumps, nubs, hooks, juts, ribs, segments, brambles, ribs, spines projections, points, protrusions, and the like. The projections on the outer surface may have any suitable shape and dimensions, and they may be arranged randomly or in a geometric order. For example, the projections may have a circular, oval, triangular, square, rectangular, pentagonal, hexagonal, heptagonal, or octagonal. Conical-shaped projections also may be used. The projections may be arranged in linear or non-linear patterns such as arcs and curves. The projections may be configured so there are gaps or channels located between them. The outer surface of inner core also may contain depressions, cavities, and the like. These recessed areas can be arranged so the outer surface has a series of peaks and valleys. In yet other embodiments, the core can include a series of packed spheres, for example, the core can have a buckyball-like construction.

Suitable projecting members and various designs, patterns, and outlays of the members including three-dimensional geometric patterns for the inner and outer cores, intermediate layers, and covers are disclosed in Sullivan et al., U.S. Pat. No. 8,137,216; 8,033,933; and 7,435,192; Morgan et al., U.S. Pat. No. 7,901,301; Sullivan et al., U.S. Pat. Nos. 7,211,007; 7,022,034; 6,929,567; 6,773,364; and 6,743,123, and 6,595,874; and Boehm, U.S. Pat. No. 6,293,877, the disclosures of which are hereby incorporated by reference. Lattice structures, which can surround the core and which contain openings so that portions of the core are exposed, as disclosed in Lemons, U.S. Pat. No. 6,398,667, the disclosure of which is hereby incorporated by reference, also can be made.

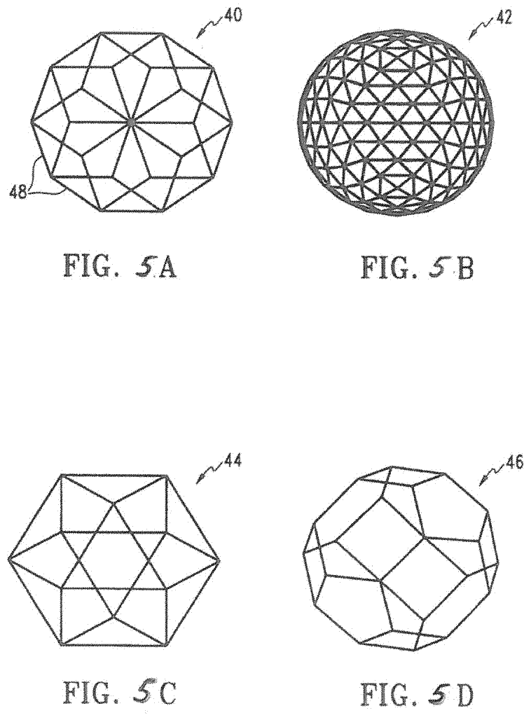

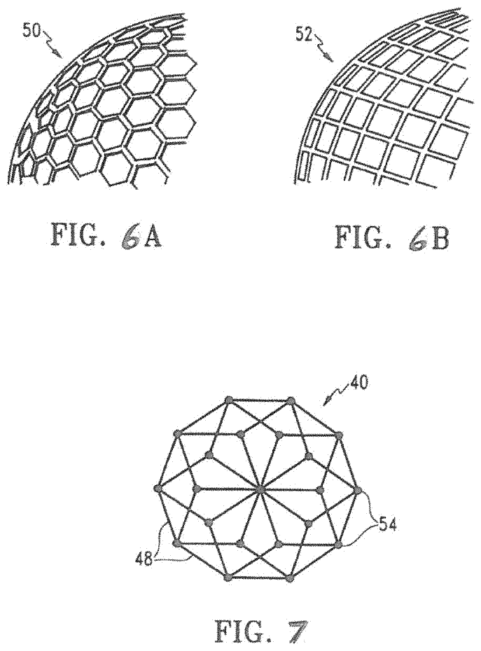

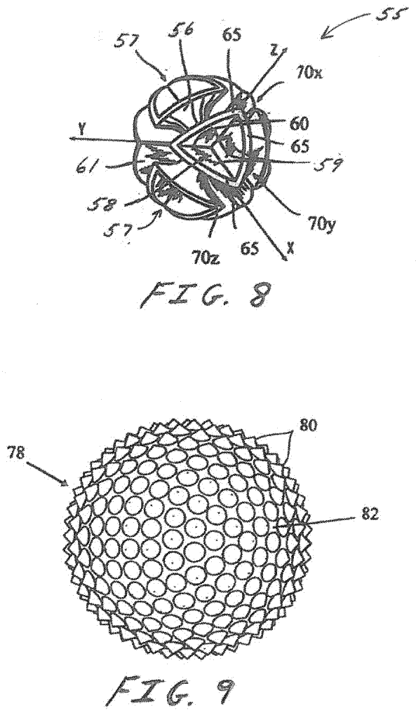

More particularly, the inner core may have a non-continuous outer surface. For example, the surface may include a screen, lattice, scrim, geodesic pattern, or perforated spherical shell. The perforations may be round, oval, square, any curved figure or any polygon. The perforations may be arranged in a pattern or in random. The non-continuous layer may also be arranged in a random pattern, such as the patterns achieved by a non-woven or sputtering application. For example, FIG. 5A shows an exemplary wire-frame geodesic screen (40) comprising a plurality of diamonds. Examples of other suitable screens include screen (42), which comprises a plurality of triangles as shown in FIG. 5B, screen (44), which comprises a plurality of squares and equilateral triangles as shown in FIG. 5C, and screen (46), which comprises a plurality of hexagons and squares as shown in FIG. 5D. Examples of perforated spherical shells (50) and (52) are shown in FIGS. 6A and 6B. Screens (40), (42), (44), and (46) and perforated shells (50) and (52) are shown herein for illustration purpose only and the invention is not so limited. The weight of the screens is preferably carried by the segments (48) so that the weight is evenly distributed throughout the inner core. Alternatively, some of the weights can be allocated to nodes (54) of the screen as shown in FIG. 7.

Referring to FIG. 8, another embodiment of an inner core (55) that can be made in accordance with this invention is shown. The inner core (55) includes a three-dimensional outer surface (56) with projections (57) and each recess (58) is formed by three integral side walls (59). The projections (57) are spaced apart to define gaps (61) there between. Each of the side walls (59) is shaped like a fiat quarter circle. The quarter circle includes two straight edges (60) joined by a curved edge (65). In each projection (57), each of the side walls (59) is joined at the straight edges (60). The curved edges (65) of each of the projections (57) allow the inner core to have a spherical outline. With reference to a three-dimensional Cartesian Coordinate system, there are perpendicular x, y, and z axii, respectively that form eight octants. There are eight projections (57) with one in each octant of the coordinate system, so that each of the projections (57) forms an octant of the skeletal sphere. Thus, the inner core is symmetrical. The gaps (61) define three perpendicular concentric rings (70ₓ, 70_{y}, and 70_{z}). The subscript for the reference number (70) designates the central axis of the ring about which the ring circumscribes.

In FIG. 9, another embodiment of an inner core (78) is shown. The inner core (78) includes a spherical central portion and a plurality of projections (80) extending radially outwardly from the surface of central portion (82). The projections (80) include a base and a pointed free end. The projections (80) are preferably conical and taper from the base to the pointed free end. The projections (80) can have other shapes, such as polygons. Examples of polygonal shapes are triangles, pentagons, and hexagons.

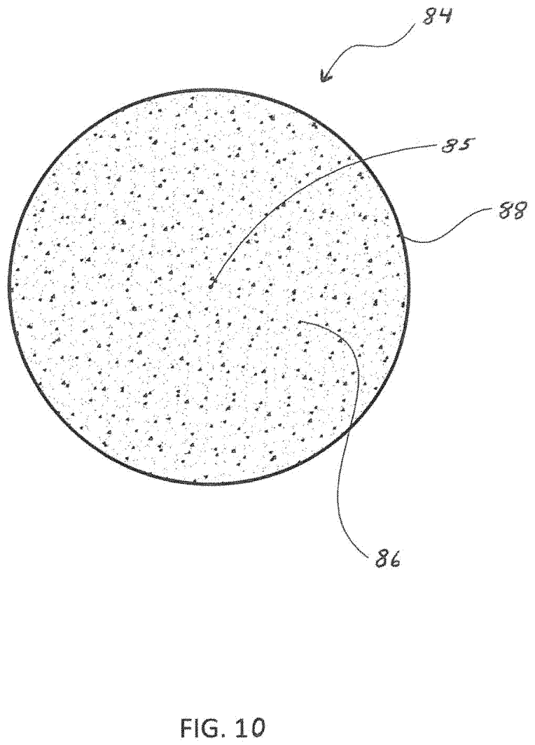

Inner cores having a foam or sponge-like interior also can be made. Turning to FIG. 10, an inner core having a cellular foam structure is shown. In general, foam compositions are made by forming gas bubbles in a polymer mixture using a foaming (blowing) agent. As the bubbles form, the mixture expands and forms a foam composition having either an open or closed cellular structure. Flexible foams generally have an open cell structure, where the cells walls are incomplete and contain small holes through which liquid and air can permeate. Rigid foams generally have a closed cell structure, where the cell walls are continuous and complete. Many foams contain both open and closed cells. In FIG. 10, a foamed inner core (84) having a geometric center (85), surrounding outer region (86), which contains a foam cellular network; and an outer skin surface (88), which is a generally dense layer and less foamed, is shown.

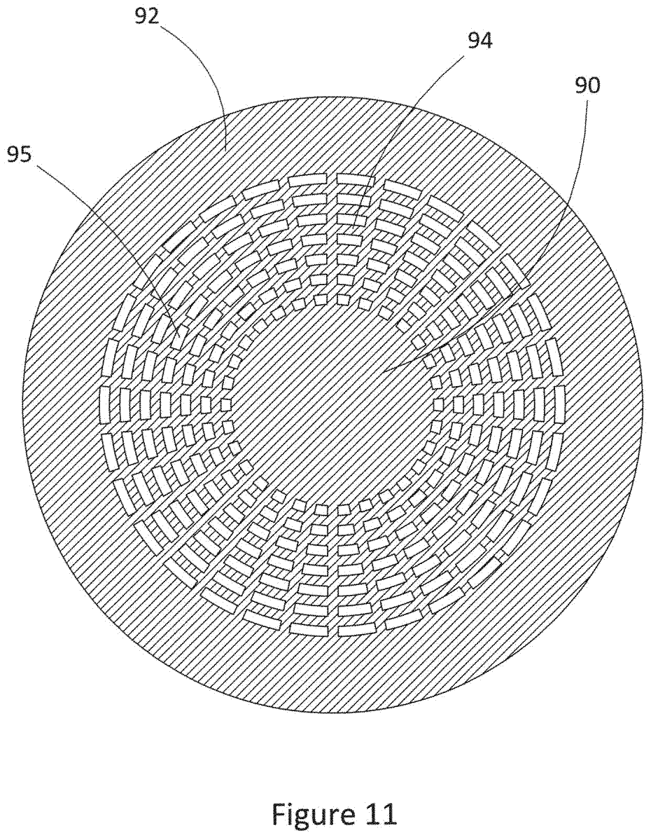

In yet another embodiment, as shown in FIG. 11, the inner core can include an interior portion (90) and an outer portion (92) connected via lattice-like structural members (94) as a single piece of the same material, such that the core contains air pockets (95) encased within the interior portion (90) of the core. The resulting lattice-like structure has a high strength to weight ratio.

Specific Gravity

In one embodiment, the overall specific gravity of the core structure (inner core and outer core layers) is preferably at least 1.8 g/cc, more preferably at least 2.00 g/cc, and most preferably at least 2.50 g/cc. In one embodiment, the inner core has a relatively low specific gravity. For example, the inner core may have a specific gravity within a range having a lower limit of about 0.80, 0.90 g/cc, 1.00 or 1.10 or 1.25 or 2.00 or 2.50 or 3.00 or 3.50 or 4.00, 4.25 or 5.00 and an upper limit of about 6.00 or 6.25 or 6.50 or 7.00 or 7.25 or 8.00 or 8.50 or 9.00 or 9.25 or 10.00 g/cc. In one preferred embodiment, the inner core has a specific gravity of about 0.80 to about 6.25 g/cc, more preferably about 1.00 to about 3.25 g/cc.

Meanwhile, in one preferred embodiment, the outer core layer has a relatively high specific gravity. Thus, the specific gravity of outer core layer (SGouter) is preferably greater than the specific gravity of the inner core layer (SGinner). For example, the outer core may have a lower limit of specific gravity of about 1.00 or 1.10 or 1.20 or 1.50 or 2.00 or 2.50 or 3.50 or 4.00 or 5.00 or 6.00 or 7.00 or 8.00 g/cc and an upper limit of about 9.00 or 9.50 or 10.00 or 10.50 or 11.00 or 12.00 or 13.00 or 14.00 or 15.00 or 16.00 or 17.00 or 18.00 or 19.00 or 19.50 or 20.00 g/cc.In one preferred embodiment, the SGₒᵤₜₑᵣ is greater than the SGᵢₙₙₑᵣ by at least 0.5 g/cc, more preferably 0.75 g/cc or greater, and even more preferably 1.00 g/cc or greater. In one embodiment, the difference between the SGₒᵤₜₑᵣ and SGᵢₙₙₑᵣ is within the range of about 0.5 g/cc to about 2.0 g/cc.

As discussed above, in one preferred embodiment, the specific gravity of the outer core layer (SGₒᵤₜₑᵣ) is greater than the specific gravity of the inner core layer (SGᵢₙₙₑᵣ).Alternatively, in another embodiment, the specific gravity of the inner core layer (SGᵢₙₙₑᵣ) is greater than the specific gravity of the outer core layer (SGₒᵤₜₑᵣ).

In general, the specific gravities of the respective pieces of an object affect the Moment of Inertia (MOI) of the object. The Moment of Inertia of a ball (or other object) about a given axis generally refers to how difficult it is to change the ball's angular motion about that axis. If the ball's mass is concentrated towards the center, less force is required to change its rotational rate, and the ball has a relatively low Moment of Inertia. In such balls, the center piece (that is, the inner core) has a higher specific gravity than the outer piece (that is, the outer core layer). In such balls, most of the mass is located close to the ball's axis of rotation and less force is needed to generate spin. Thus, the ball has a generally high spin rate as the ball leaves the club's face after making impact. Because of the high spin rate, amateur golfers may have a difficult time controlling the ball and hitting it in a relatively straight line. Such high-spin balls tend to have a side-spin so that when a golfer hook or slices the ball, it may drift off-course.

Conversely, if the ball's mass is concentrated towards the outer surface, more force is required to change its rotational rate, and the ball has a relatively high Moment of Inertia. In such balls, the center piece (that is, the inner core) has a lower specific gravity than the outer piece (that is, the outer core layer). That is, in such balls, most of the mass is located away from the ball's axis of rotation and more force is needed to generate spin. Thus, the ball has a generally low spin rate as the ball leaves the club's face after making impact. Because of the low spin rate, amateur golfers may have an easier time controlling the ball and hitting it in a relatively straight line. The ball tends to travel a greater distance which is particularly important for driver shots off the tee.

As described in Sullivan, U.S. Pat. No. 6,494,795 and Ladd et al., U.S. Pat. No. 7,651,415, the formula for the Moment of Inertia for a sphere through any diameter is given in the CRC Standard Mathematical Tables, 24th Edition, 1976 at 20 (hereinafter CRC reference). In the present invention, the finished golf balls preferably have a Moment of Inertia in the range of about 55.0 g./cm² to about 95.0 g./cm², preferably about 62.0 g./cm² to about 92.0 g./cm² The term, “specific gravity” as used herein, has its ordinary and customary meaning, that is, the ratio of the density of a substance to the density of water at 4° C., and the density of water at this temperature is 1 g/cm³.

In one embodiment, the golf balls of this invention tend to have a low Moment of Inertia (MOI) and are relatively high spin. The above-described core construction (wherein the inner core contains projecting members on its outer surface) and wherein the specific gravity of the inner core is greater than the specific gravity of the outer core (SG_{center}>SG_{outer core}) contributes to a ball having relatively high spin. Most of the ball's mass is located near the ball's center (axis of rotation) and this helps produce a higher spin rate. The cores and resulting balls also have relatively high resiliency so the ball will reach a relatively high velocity when struck by a golf club and travel a long distance.

In an alternative embodiment, the golf balls tend to have a high Moment of Inertia (MOI) and are relatively low spin. The core can have a structure such that most of the ball's mass is located near the ball's surface and this helps produce a lower spin rate. In such embodiments, the specific gravity of the inner core is preferably less than the specific gravity of the outer core (SG_{center}<SG_{outer core}).

The cores of this invention typically have a Coefficient of Restitution (COR) of about 0.75 or greater; and preferably about 0.80 or greater. The compression of the core preferably is about 50 to about 130 and more preferably in the range of about 70 to about 110. In other embodiments, cores having softer compressions (for example, less than 50) can be made.

Concerning the total weight and dimensions of the ball, the United States Golf Association (USGA) has established a maximum weight of 45.93 g (1.62 ounces) for golf balls. For play outside of USGA rules, the golf balls can be heavier. In one preferred embodiment, the weight of the multi-layered core is in the range of about 28 to about 38 grams. Also, golf balls made in accordance with this invention can be of any size, although the USGA requires that golf balls used in competition have a diameter of at least 1.68 inches. For play outside of USGA rules, the golf balls can be of a smaller size. Normally, golf balls are manufactured in accordance with USGA requirements and have a diameter in the range of about 1.68 to about 1.80 inches. As discussed further below, the golf ball contains a cover which may be multi-layered and in addition may contain intermediate (casing) layers, and the thickness levels of these layers also must be considered. Thus, in general, the inner core preferably has a diameter within a range of about 0.100 to about 1.200 inches, and the dual-layered core sub-assembly (inner core and surrounding outer core layer) normally has an overall diameter within a range of about 1.00 to about 1.66 inches. For example, the inner core may have a diameter within a range of about 0.500 to about 1.000 inches. In another example, the inner core may have a diameter within a range of about 0.650 to about 0.850 inches. In yet another example, a very small inner core (for example, a core having a diameter of about 0.250 inches) may be made. The method of this invention is particularly effective in making very small inner cores. In one embodiment, the diameter of the core sub-assembly is in the range of about 1.15 to about 1.65 inches.

Intermediate Layer

As discussed above, the inner core can have various structures and it can be made of various materials including thermoset rubbers and thermoplastics, for example, ethylene acid copolymer ionomers as described above. The intermediate layer, which surrounds the inner core, also can be made of such materials.

These polymer compositions also may include filler(s) such as materials selected from carbon black, clay and nanoclay particles as discussed above, talc (e.g., Luzenac HAR® high aspect ratio talcs, commercially available from Luzenac America, Inc.), glass (e.g., glass flake, milled glass, and microglass), mica and mica-based pigments (e.g., Iriodin® pearl luster pigments, commercially available from The Merck Group), and combinations thereof. In addition, the rubber compositions may include antioxidants. Other ingredients such as accelerators, processing aids, dyes and pigments, wetting agents, surfactants, plasticizers, coloring agents, fluorescent agents, chemical blowing and foaming agents, defoaming agents, stabilizers, softening agents, impact modifiers, antiozonants, as well as other additives known in the art may be added to the compositions.

Cover Layer

The golf ball sub-assemblies of this invention may be enclosed with one or more cover layers. The golf ball sub-assembly may comprise the multi-layered core structure as discussed above. In other versions, the golf ball sub-assembly includes the core structure and one or more intermediate (casing) layers disposed about the core. The cover, which surrounds the ball sub-assembly can be made using the above-described three-dimensional manufacturing methods. Alternatively, the cover can be made using conventional molding or casting processes. In one particularly preferred version, the golf ball includes a multi-layered cover comprising inner and outer cover layers.

In such embodiments, the inner cover layer may be formed from a composition comprising an ionomer or a blend of two or more ionomers that helps impart hardness to the ball. In a particular embodiment, the inner cover layer is formed from a composition comprising a high acid ionomer. A particularly suitable high acid ionomer is Surlyn 8150® (DuPont). Surlyn 8150® is a copolymer of ethylene and methacrylic acid, having an acid content of 19 wt %, which is 45% neutralized with sodium. In another particular embodiment, the inner cover layer is formed from a composition comprising a high acid ionomer and a maleic anhydride-grafted non-ionomeric polymer. A particularly suitable maleic anhydride-grafted polymer is Fusabond 525D® (DuPont). Fusabond 525D® is a maleic anhydride-grafted, metallocene-catalyzed ethylene-butene copolymer having about 0.9 wt % maleic anhydride grafted onto the copolymer. A particularly preferred blend of high acid ionomer and maleic anhydride-grafted polymer is an 84 wt %/16 wt % blend of Surlyn 8150® and Fusabond 525D®. Blends of high acid ionomers with maleic anhydride-grafted polymers are further disclosed, for example, in U.S. Pat. Nos. 6,992,135 and 6,677,401, the entire disclosures of which are hereby incorporated herein by reference.

The inner cover layer also may be formed from a composition comprising a 50/45/5 blend of Surlyn® 8940/Surlyn® 9650/Nucrel® 960, and, in a particularly preferred embodiment, the composition has a material hardness of from 80 to 85 Shore C. In yet another version, the inner cover layer is formed from a composition comprising a 50/25/25 blend of Surlyn® 8940/Surlyn® 9650/Surlyn® 9910, preferably having a material hardness of about 90 Shore C. The inner cover layer also may be formed from a composition comprising a 50/50 blend of Surlyn® 8940/Surlyn® 9650, preferably having a material hardness of about 86 Shore C. A composition comprising a 50/50 blend of Surlyn® 8940 and Surlyn® 7940 also may be used. Surlyn® 8940 is an E/MAA copolymer in which the MAA acid groups have been partially neutralized with sodium ions. Surlyn® 9650 and Surlyn® 9910 are two different grades of E/MAA copolymer in which the MAA acid groups have been partially neutralized with zinc ions. Nucrel® 960 is an E/MAA copolymer resin nominally made with 15 wt % methacrylic acid.

A wide variety of materials may be used for forming the outer cover including, for example, polyurethanes; polyureas; copolymers, blends and hybrids of polyurethane and polyurea; olefin-based copolymer ionomer resins (for example, Surlyn® ionomer resins and DuPont HPF® 1000 and HPF® 2000, commercially available from DuPont; Iotek® ionomers, commercially available from ExxonMobil Chemical Company; Amplify® IO ionomers of ethylene acrylic acid copolymers, commercially available from The Dow Chemical Company; and Clarix® ionomer resins, commercially available from A. Schulman Inc.); polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax® thermoplastic polyether block amides, commercially available from Arkema Inc; cross-linked trans-polyisoprene and blends thereof; polyester-based thermoplastic elastomers, such as Hytrel®, commercially available from DuPont or RiteFlex®, commercially available from Ticona Engineering Polymers; polyurethane-based thermoplastic elastomers, such as Elastollan®, commercially available from BASF; synthetic or natural vulcanized rubber; and combinations thereof. Castable polyurethanes, polyureas, and hybrids of polyurethanes-polyureas are particularly desirable because these materials can be used to make a golf ball having high resiliency and a soft feel. By the term, “hybrids of polyurethane and polyurea,” it is meant to include copolymers and blends thereof.

Polyurethanes, polyureas, and blends, copolymers, and hybrids of polyurethane/polyurea are also particularly suitable for forming cover layers. When used as cover layer materials, polyurethanes and polyureas can be thermoset or thermoplastic. Thermoset materials can be formed into golf ball layers by conventional casting or reaction injection molding techniques. Thermoplastic materials can be formed into golf ball layers by conventional compression or injection molding techniques.

Other suitable thermoplastic polymers that may be used to form the inner and outer cover layers include, but are not limited to, the following polymers (including homopolymers, copolymers, and derivatives thereof): a) polyesters, b) polyamides, c)polyurethanes, polyureas, polyurethane-polyurea hybrids, d) fluoropolymers, e) polystyrenes, f) polyvinyl chlorides, g) polycarbonates, h) polyethers, i) polyimides, polyetherketones, polyamideimides; and j) blends of two or more of the foregoing.

The compositions used to make the intermediate (casing) and cover layers may contain a wide variety of fillers and additives to impart specific properties to the ball. These additives and fillers include, but are not limited to, metals, glass, ceramics, pigments, optical brighteners, coloring agents, fluorescent agents, whitening agents, UV absorbers, light stabilizers, surfactants, processing aids, antioxidants, stabilizers, softening agents, fragrance components, plasticizers, impact modifiers, titanium dioxide, clay, mica, talc, glass flakes, milled glass, and mixtures thereof.

The cover layers are formed over the core or ball subassembly (the core structure and any intermediate (casing) layers disposed about the core) using a suitable technique such as, for example, compression-molding, flip-molding, injection-molding, retractable pin injection-molding, reaction injection-molding (RIM), liquid injection-molding, casting, spraying, powder-coating, vacuum-forming, flow-coating, dipping, spin-coating, and the like. Preferably, each cover layer is separately formed over the ball subassembly. For example, an ethylene acid copolymer ionomer composition may be injection-molded to produce half-shells. Alternatively, the ionomer composition can be placed into a compression mold and molded under sufficient pressure, temperature, and time to produce the hemispherical shells. The smooth-surfaced hemispherical shells are then placed around the ball subassembly in a compression mold. Under sufficient heating and pressure, the shells fuse together to form an inner cover layer that surrounds the subassembly. In another method, the ionomer composition is injection-molded directly onto the core using retractable pin injection molding. An outer cover layer comprising a polyurethane or polyurea composition may be formed by using a casting process.

After the golf balls have been removed from the mold, they may be subjected to finishing steps such as flash-trimming, surface-treatment, marking, coating, and the like using techniques known in the art. For example, in traditional white-colored golf balls, the white-pigmented cover may be surface-treated using a suitable method such as, for example, corona, plasma, or ultraviolet (UV) light-treatment. Then, indicia such as trademarks, symbols, logos, letters, and the like may be printed on the ball's cover using pad-printing, ink-jet printing, dye-sublimation, or other suitable printing methods. Clear surface coatings (for example, primer and top-coats), which may contain a fluorescent whitening agent, are applied to the cover. The resulting golf ball has a glossy and durable surface finish.

In another finishing process, the golf balls are painted with one or more paint coatings. For example, white primer paint may be applied first to the surface of the ball and then a white top-coat of paint may be applied over the primer. Of course, the golf ball may be painted with other colors, for example, red, blue, orange, and yellow. As noted above, markings such as trademarks and logos may be applied to the painted cover of the golf ball. Finally, a clear surface coating may be applied to the cover to provide a shiny appearance and protect any logos and other markings printed on the ball.

Different ball constructions can be made using the different core constructions of this invention as shown in FIGS. 1-16D discussed above. Such golf ball designs include, for example, one-piece, two-piece, three-piece, four-piece, five-piece, and six-piece designs. It should be understood that the core constructions and golf balls shown in FIGS. 1-16D are for illustrative purposes only and are not meant to be restrictive. Other core constructions and golf balls can be made in accordance with this invention. It is anticipated that the hollow center golf balls of this invention will meet the high demands of today's golf ball industry including having good resiliency, impact durability, toughness, and wear and tear-resistance.

It also is recognized that the skeletal structures used in the golf balls of this invention as described above could be used to construct game balls in other sports such as, for example, softball, baseball, basketball, soccer, lacrosse, paddleball, tennis, and racquetball. The skeletal structures also could be used to construct hockey pucks, blades or shafts for hockey sticks, golf club shafts, golf club heads (for example, woods, hybrids, and putters); and racket frames for paddleball, tennis, and racquetball. These skeletal structures also could be used be used in the construction of shoes and sneakers.

When numerical lower limits and numerical upper limits are set forth herein, it is contemplated that any combination of these values may be used. Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention.

All patents, publications, test procedures, and other references cited herein, including priority documents, are fully incorporated by reference to the extent such disclosure is not inconsistent with this invention. It is understood that the compositions, ball components, and finished golf balls described and illustrated herein represent only some embodiments of the invention. It is appreciated by those skilled in the art that various changes and additions can be made to compositions and products without departing from the spirit and scope of this invention. It is intended that all such embodiments be covered by the appended claims.

We claim:

1. A golf ball, comprising:
a) a core having at least one layer;
b) a spherical-shaped shell having an outer surface, the shell comprising a plurality of apertures on the outer surface that form hollow compartments; and
c) a cover layer having an outer surface, the cover layer being disposed about the shell and comprising a plurality of dimples on the outer surface;
d) a hollow area disposed between the shell and cover, wherein the shape of the shell is capable of at least partially deforming upon impact by a golf club and recovering to its original shape after impact.

2. The golf ball of claim 1, wherein the core layer has a hollow interior region.

3. The golf ball of claim 2, wherein the hollow interior region of the core layer and hollow area disposed between the shell and cover comprises a gas selected from the group consisting of air, nitrogen, helium, argon, neon, carbon dioxide, nitrous oxide and mixtures thereof.

4. The golf ball of claim 2, wherein the hollow interior region of the core layer and hollow area disposed between the shell and cover comprises a liquid.

5. The golf ball of claim 5, wherein the liquid is a water solution.

6. The golf ball of claim 2, wherein the core and shell each comprises a thermoplastic material.

7. The golf ball of claim 2, wherein the core and shell each comprises a thermoset rubber material.

8. A golf ball, comprising:
a) a core having at least one layer;
b) an outer shell disposed about the core, the outer shell having a spherical shape and comprising apertures that form hollow compartments;
c) a foam-filled area disposed between the core and outer shell, wherein the shape of the outer shell is capable of at least partially deforming upon impact by a golf club and recovering to its original shape after impact.

9. The golf ball of claim 8, wherein the foam-filled area comprises a foam selected from the group consisting of polyurethane and ethylene vinyl acetate foam, and mixtures thereof.

10. A golf ball, comprising:
a) a core having at least one layer;
b) an outer shell disposed about the core, the outer shell having a spherical shape and comprising apertures that form hollow compartments;
c) a liquid-filled area disposed between the core and outer shell, wherein the shape of the outer shell is capable of at least partially deforming upon impact by a golf club and recovering to its original shape after impact.

11. The golf ball of claim 10, wherein the outer shell comprises a thermoplastic material.

12. The golf ball of claim 10, wherein the outer shell comprises a thermoset rubber material.

13. The golf ball of claim 10, wherein the outer shell has a surface comprising segments in a lattice pattern.

14. The golf ball of claim 10, wherein the outer shell has a surface comprising segments in a grid pattern.

15. The golf ball of claim 10, wherein the golf ball further comprises a cover layer surrounding the outer shell.

16. The golf ball of claim 15, wherein the golf ball further comprises an intermediate layer disposed between the cover layer and outer shell.

17. A golf ball, comprising:
a) a spherical-shaped shell having an outer surface, the shell comprising a plurality of apertures on the outer surface that form hollow compartments; and
b) a cover layer having an outer surface, the cover layer being disposed about the shell and comprising a plurality of dimples on the outer surface;
c) a hollow area disposed between the shell and cover, wherein the shape of the shell is capable of at least partially deforming upon impact by a golf club and recovering to its original shape after impact.

18. The golf ball of claim 17, wherein the shell and cover and hollow area form a unitary piece.
